(19) United States
(12) Patent Application Publication
(10) Pub. No.: US 2013/0063332 A1
(43) Pub. Date: Mar. 14, 2013

(54) DISPLAY DEVICE, DISPLAY METHOD, AND ELECTRONIC APPARATUS

(71) Applicant: Yuichi Inoue, Kanagawa (JP)

(72) Inventor: Yuichi Inoue, Kanagawa (JP)

(73) Assignee: SONY CORPORATION, Tokyo (JP)

(21) Appl. No.: 13/602,826

(22) Filed: Sep. 4, 2012

(30) Foreign Application Priority Data
Sep. 8, 2011 (JP) 2011-196400

(51) Int. Cl. G09G 3/36

(52) U.S. Cl. 345/102

(57) ABSTRACT

A display device includes a liquid crystal display part and a light control part. The liquid crystal display part is configured to have an array of pixels each including a plurality of segments each driven independently. Further, the light control part is configured to control light coming from or directed to the liquid crystal display part. In a first display mode provided by the display device, a plurality of pixel signals derived from different items of pixel information are supplied respectively to the plurality of segments in each of the pixels.

### CROSS REFERENCES TO RELATED APPLICATIONS

The present application claims priority to Japanese Priority Patent Application JP 2011-196400 filed in the Japan Patent Office on Sep. 8, 2011, the entire content of which is hereby incorporated by reference.

### BACKGROUND

The present disclosure relates to a display device capable of three-dimensional display, a display method for use with the same display device, and an electronic apparatus configured to include the same display device.

In recent years, display devices capable of three-dimensional display have been drawing attention. Three-dimensional display involves displaying a left-eye image and a right-eye image with a parallax difference therebetween (i.e., from different perspectives) so that an observer may view the two images with his or her respective eyes to recognize a solid image with a depth. Also developed are display devices capable of offering the observer a more natural stereoscopic image derived from three or more displayed images with a parallax difference therebetween.

These display devices fall into two categories: those requiring the observer to wear dedicated goggles, and those with no need for goggles. Wearing the dedicated goggles is an awkward experience for the observer, so that the devices requiring no goggles are more sought after than those that need them. The display devices with no need for dedicated goggles include the parallax battier type and lenticular lens type, for example. These types of devices display simultaneously a plurality of images (perspective images) with a parallax difference therebetween so that a different image can be seen depending on the relative positional relation (i.e., angle) between the display device and the observer's perspective. For example, Japanese Patent Laid-open No. Hei 3-119889 (referred to as Patent Document 1 hereinafter) discloses a parallax barrier type display device that uses liquid crystal elements as the barrier.

Meanwhile, it is generally desired that the observer observe good images on the display screen from various directions (up, down, right, left). In order to obtain such extensive view angles, diverse methods have been proposed. For example, Japanese Patent Laid-open Nos. Hei 6-332009 (referred to as Patent Document 2 hereinafter) and 2006-189684 (referred to as Patent Document 3 hereinafter) disclose display devices that divide each pixel electrode into a plurality of sub-pixel electrodes to which pixel voltages are applied at different ratios.

### SUMMARY

Generally, display devices capable of three-dimensional display tend to offer lower resolution of displayed images when displaying a larger number of perspective images or to provide a smaller number of perspective images displayed when raising the resolution of the displayed images. Thus it has been difficult for these display devices to improve the image quality of three-dimensional display. Moreover, Patent Document 2 and Patent Document 3 contain no reference to three-dimensional display.

The present disclosure has been made in view of the above circumstances and provides a display device, a display method, and an electronic apparatus capable of improving image quality.

In carrying out the present disclosure and according to one embodiment thereof, there is provided a display device including a liquid crystal display part and a light control part. The liquid crystal display part has an array of pixels each including a plurality of segments each driven independently. The light control part controls light coming from or directed to the liquid crystal display part. In a first display mode provided by the display device, a plurality of pixel signals derived from different items of pixel information are supplied respectively to the plurality of segments in each of the pixels.

According to another embodiment of the present disclosure, there is provided a display method which, in the first display mode, supplies a plurality of pixel signals derived from different items of pixel information respectively to a plurality of segments included in each of pixels and driven independently for display execution; causes each of the segments to execute display based on the pixel signals, and controls light coming from or directed to each of the segments.

According a further embodiment of the present disclosure, there is provided an electronic apparatus including the above-outlined display device, and a control part configured to perform operation control using the display device. For example, the electronic apparatus may be a TV set, a digital camera, a personal computer, a video camera, or portable terminal equipment such as a mobile phone.

Where the above-outlined display device, display method, and electronic apparatus of the present disclosure are in use, the light control part controls light to let the observer visually recognize the display by a plurality of segments in each of the pixels involved. At this time, the plurality of segments in each pixel are supplied respectively with a plurality of pixel signals derived from different pieces of pixel information in the first display mode.

According to the display device, display method, and electronic apparatus of the present disclosure, it is possible to improve image quality because a plurality of pixel signals derived from different items of pixel information are supplied respectively to a plurality of segments in each pixel.

Additional features and advantages are described herein, and will be apparent from the following Detailed Description and the figures.

### BRIEF DESCRIPTION OF THE FIGURES

FIG. 1 is a block diagram showing a typical configuration of a three-dimensional display device as a first embodiment of the present disclosure;

FIGS. 2A and 2B are explanatory views showing a typical structure of the three-dimensional display device indicated in FIG. 1;

FIG. 3 is a block diagram showing a typical configuration of a display drive part indicated in FIG. 1;

FIG. 4 is an explanatory view showing a typical structure of a display part as part of the first embodiment;

FIGS. 5A and 5B are a circuit diagram and a cross-sectional view showing a typical structure of the display part indicated in FIG. 4;

FIGS. 6A, 6B and 6C are schematic views showing the typical workings of a liquid crystal layer indicated in FIG. 5B;

FIGS. 7A and 7B are explanatory views showing a typical structure of a barrier part indicated in FIG. 1;

FIG. 8 is an explanatory view showing the positional relation between the display part and barrier part indicated in FIG. 1;

FIGS. 9A, 9B and 9C are schematic views showing the typical workings of the display part indicated in FIG. 4;

FIG. 10 is a characteristic diagram showing typical characteristics of the display part shown in FIG. 4;

FIG. 11 is a schematic view showing the typical workings of the liquid crystal layer shown in FIGS. 5A and 5B and operating in its half tone state;

FIG. 12 is a characteristic diagram showing typical view angle characteristics of the display part indicated in FIG. 4;

FIGS. 13A, 13B and 13C are schematic views showing the typical workings of three-dimensional display performed by the three-dimensional display device indicated in FIG. 1;

FIG. 14 is an explanatory view showing the display part of a comparative example;

FIG. 15 is a schematic view showing the typical workings of the liquid crystal layer of the comparative example in its half tone state;

FIG. 16 is a characteristic diagram showing typical view angle characteristics of the display part in the comparative example;

FIG. 17 is a schematic view showing the typical workings of three-dimensional display performed by a three-dimensional display device of the comparative example;

FIG. 18 is a circuit diagram showing a typical structure of a display part as a variation of the first embodiment;

FIG. 19 is an explanatory view showing the positional relation between the display part and barrier part as another variation of the first embodiment;

FIG. 20 is an explanatory view showing a typical structure of a display part as another variation of the first embodiment;

FIG. 21 is an explanatory view showing the positional relation between the display part and barrier part as another variation of the first embodiment;

FIG. 22 is a schematic view showing the typical workings of three-dimensional display performed by a three-dimensional display device as another variation of the first embodiment;

FIG. 23 is an explanatory view showing the positional relation between the display part and barrier part in a second embodiment of the present disclosure;

FIG. 24 is an explanatory view showing the positional relation between the display part and barrier part as a variation of the second embodiment;

FIG. 25 is an explanatory view showing the positional relation between the display part and barrier part as another variation of the second embodiment;

FIG. 26 is a perspective view showing an external structure of a television set to which the three-dimensional display device embodying the present disclosure is applied;

FIGS. 27A and 27B are explanatory views showing a typical structure of another variation of the three-dimensional display device;

FIGS. 28A, 28B and 28C are schematic views showing the typical workings of three-dimensional display performed by the preceding variation of the three-dimensional display device; and

FIGS. 29A, 29B and 29C are schematic views showing the typical workings of three-dimensional display performed by a three-dimensional display device as another variation.

### DETAILED DESCRIPTION

Some preferred embodiments of the present disclosure will now be described below in detail by reference to the accompanying drawings. The description will be given under the following headings:

1. First embodiment;
2. Second embodiment; and
3. Examples of application

### 1. First Embodiment

[Typical Structures]

(Typical Overall Configuration)

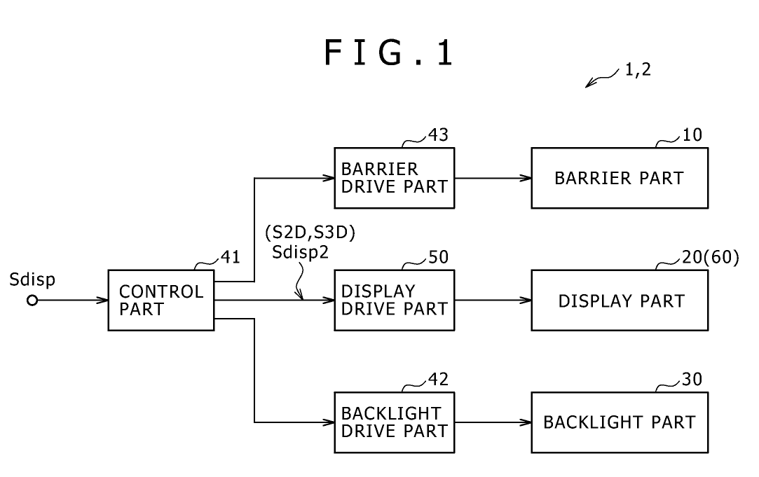

FIG. 1 shows a typical configuration of a three-dimensional display device 1 embodying the present disclosure. The three-dimensional display device 1 is a parallax barrier type display device that uses liquid barriers. Since a display method also embodying the present disclosure is implemented in conjunction with the device 1, this method and the device 1 will be discussed in tandem hereunder. The three-dimensional display device 1 includes a control part 41, a backlight drive part 42, a backlight part 30, a display drive part 50, a display part 20, a barrier drive part 43, and a barrier part 10.

Based on an externally supplied image signal Sdisp, the control part 41 supplies control signals to the backlight drive part 42, display drive part 50, and barrier driver part 43 so that these parts are controlled to operate in synchronism with one another. Specifically, the control part 41 supplies the backlight drive part 42 with a backlight control signal, the display drive part 50 with an image signal Sdisp2 generated from the video signal Sdisp, and the barrier drive part 43 with a barrier control signal. Where the three-dimensional display device 1 performs normal display (two-dimensional display), the image signal Sdisp2 is an image signal S2D including one perspective image. Where the three-dimensional display device 1 performs three-dimensional display, the image signal Sdisp2 constitutes an image signal S3D including a plurality (10 with this example) of perspective images, as will be discussed later.

The backlight drive part 42 drives the backlight part 30 based on the backlight control signal supplied from the control part 41. The backlight part 30 has a function of applying flat-emitted light to the display part 20. The backlight part 30 is typically composed of LED's (light emitting diodes) or CCFL's (cold cathode fluorescent lamps).

The display drive part 50 drives the display part 20 based on the image signal Sdisp2 from the control part 41. In this example, the display part 20 is constituted by a liquid crystal display portion of which the liquid crystal display elements are driven to modulate the light coming from the backlight part 30, whereby display is implemented.

The barrier drive part 43 drives the barrier part 10 based on the barrier control signal fed from the control part 41. The barrier part 10 lets pass (in an open operation) or blocks (in a close operation) the light emitted from the backlight part 30 and transmitted past the display part 20. The barrier part 10 includes a plurality of opening/closing portions 11 and 12 (to be discussed later) formed by use of liquid crystal.

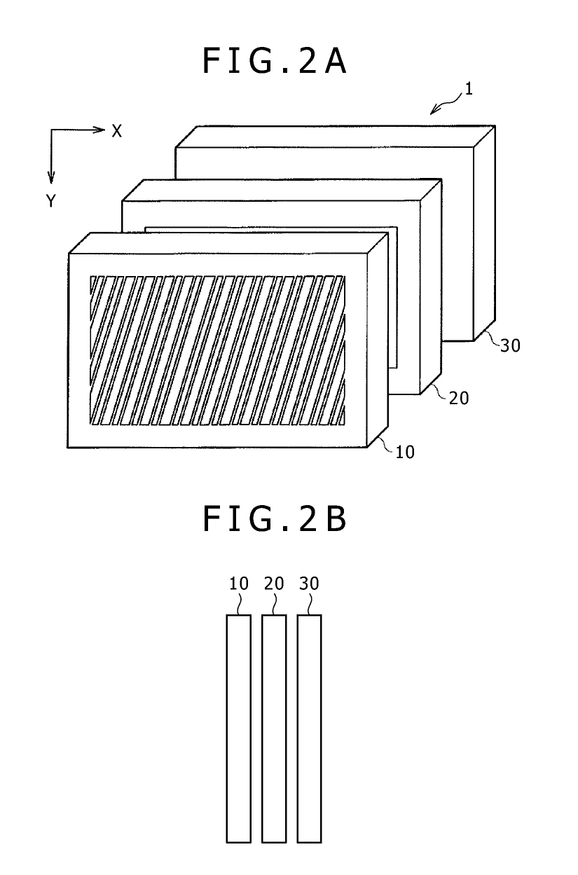

FIGS. 2A and 2B show a typical structure made up of key parts of the three-dimensional display device 1. FIG. 2A is an exploded perspective view of the three-dimensional display device 1, and FIG. 2B is a side view of the three-dimensional display device 1. As shown in FIGS. 2A and 2B, the key parts of the three-dimensional display device 1 are arrayed so that the backlight part 30 is fronted by the display part 20 which in turn is fronted by the barrier 10. That is, the light emitted by the backlight part 30 reaches the observer past the display part 20 and barrier part 10.

(Display Drive Part 50 and Display Part 20)

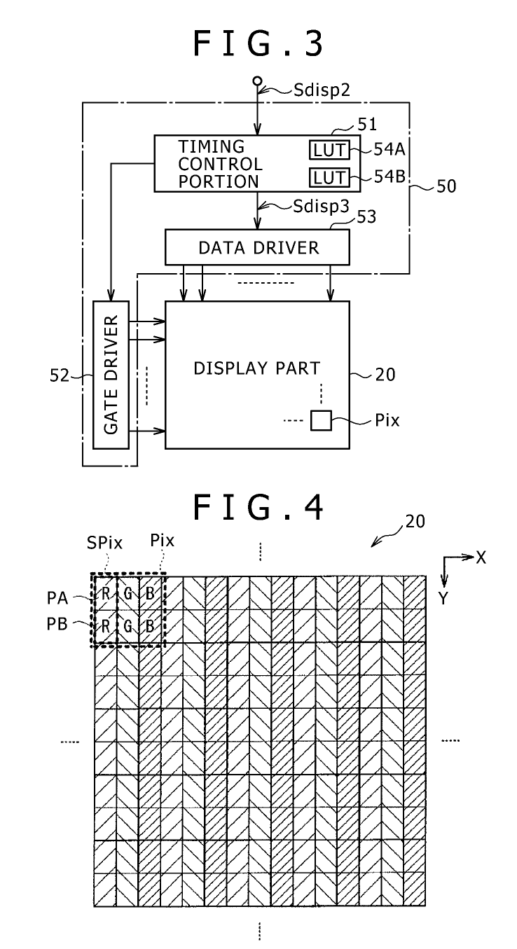

FIG. 3 is a typical block diagram of the display drive part 50. The display drive part 50 includes a timing control portion 51, a gate driver 52, and a data driver 53. The timing control portion 51 controls the drive timings of the gate driver 52 and data driver 53 and, based on the image signal Sdisp2 coming from the control part 41, generates an image signal Sdisp3 and supplies the generated signal to the data driver 53. The gate driver 52 under timing control of the timing control portion 51 selects pixels Pix inside the display part 20 one line at a time for line-sequential scanning The data driver 53 supplies each pixel Pix in the display part 20 with a pixel signal based on the image signal Sdisp3. Specifically, the data driver 53 generates the pixel signal as an analog signal by subjecting the image signal Sdisp3 to D/A (digital/analog) conversion, before feeding the generated pixel signal to each pixel Pix.

The timing control portion 51 includes look-up tables (LUT's) 54A and 54B. The LUT's 54A and 54B are tables for use in performing so-called gamma correction on the pixel information (intensity information) about each pixel included in the image signal Sdisp2. The LUT 54A is a table for a sub-pixel segment PA (to be discussed later) of a sub-pixel SPix, and the LUT 54B is a table for a sub-pixel segment PB (to be discussed later) of the sub-pixel SPix. As will be explained later, the LUT 54A and LUT 54B are set to be different from each other when the three-dimensional display device 1 performs normal display (two-dimensional display); the LUT 54A and LUT 54B are set to be the same when the three-dimensional display device 1 performs three-dimensional display. The timing control portion 51 generates the image signal Sdisp3 based on the gamma-corrected pixel information (intensity information). The data driver 53 generates the pixel signal on the basis of the gamma-corrected pixel information (intensity information) and feeds the generated pixel signal to each pixel Pix.

Specifically, when the three-dimensional display device 1 performs normal display (two-dimensional display), the timing control portion 51 carries out gamma correction on a given item of pixel information (intensity information) differently using the LUT's 54A and 54B. The data driver 53 supplies the sub-pixel segment PA of a given sub-pixel SPix with a pixel signal generated using the LUT 54A and the sub-pixel segment PB of the sub-pixel SPix in question with a pixel signal generated using the LUT 54B. The display part 20 then allows the sub-pixel segments PA and PB to execute their display based on the pixel signals respectively, as will be discussed later. That is, for normal display, the sub-pixel segments PA and PB display one item of pixel information using different gamma characteristics through so-called half-tone drive.

When the three-dimensional display device 1 performs three-dimensional display, the timing control portion 51 carries out gamma correction on pixel information (intensity information) about different perspective images using the LUT's 54A and 54B respectively. The data driver 53 supplies the sub-pixel segment PA of a given sub-pixel SPix with a pixel signal generated using the LUT 54A and the sub-pixel segment PB of the sub-pixel SPix in question with a pixel signal generated using the LUT 54B. The display part 20 then allows the sub-pixel segments PA and PB to execute their display independently of one another based on such pixel information.

FIG. 4 shows an array of pixels Pix in the display part 20. The display part 20 has the pixels Pix arranged in a matrix pattern. Each pixel Pix has three sub-pixels SPix corresponding to the colors of red (R), green (G) and blue (B). In this example, the sub-pixels SPix of red (R), green (G) and blue (B) are arrayed repeatedly, in that order, in the horizontal direction X. In the vertical direction Y, the sub-pixels SPix of the same color are arrayed repeatedly. In the drawings to be cited below, the sub-pixels SPix of the different colors will be shown hatched differently for purpose of distinction between them.

Each sub-pixel SPix has sub-pixel segments PA and PB. In this example, the sub-pixel segments PA and PB are arrayed in the vertical direction Y inside the sub-pixel SPix. The sub-pixel segments PA and PB are configured to provide display independently. Specifically, when the three-dimensional display device 1 performs normal display (two-dimensional display), the sub-pixel segments PA and PB provide the display based on given pixel information about one perspective image. When the three-dimensional display device 1 performs three-dimensional display, the sub-pixel segments PA and PB provide the display based on pixel information about different perspective images.

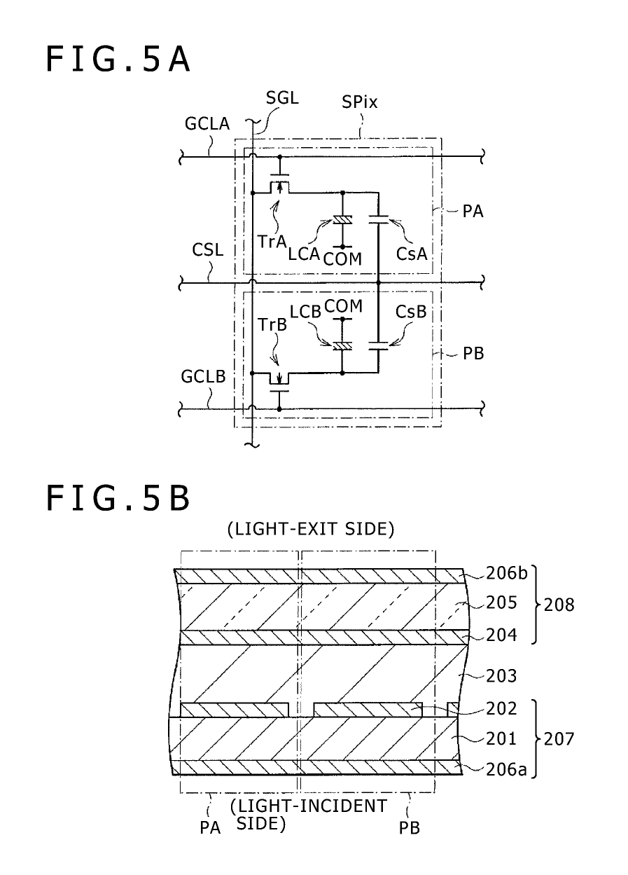

FIGS. 5A and 5B show a typical structure of the display part 20. FIG. 5A is a typical circuit diagram of the sub-pixel SPix, and FIG. 5B shows a cross-sectional structure of the display part 20.

As shown in FIG. 5A, the sub-pixel segments PA and PB of the sub-pixel SPix are each composed of TFT (thin film transistor) elements Tr (TrA, TrB) each formed by an MOS-FET (metal oxide semiconductor-field effect transistor), of liquid crystal elements LC (LCA, LCB), and of storage capacitors Cs (CsA, CsB). Specifically, the sub-pixel segment PA includes a TFT element TrA, a liquid crystal element LCA, and a storage capacitor CsA. The gate and source of the TFT element TrA are connected to a gate line GCLA and a data line SGL, respectively. The drain of the TFT element TrA is connected to one end of the liquid crystal element LCA and to one end of the storage capacitor CsA. One end of the liquid crystal element LCA is connected to the drain of the TFT element TrA and the other end is connected to a common electrode COM and grounded. One end of the storage capacitor CsA is connected to the drain of the TFT element TrA and the other end is connected to a storage capacity line CSL. Likewise, the sub-pixel segment PB includes a TFT element TrB, a liquid crystal element LCB, and a storage capacitor CsB. The gate and source of the TFT element TrB are connected to a gate line GCLB and the data line SGL, respectively. The drain of the TFT element TrB is connected to one end of the liquid crystal element LCB and to one end of the storage capacitor CsB. One end of the liquid crystal element LCB is connected to the drain of the TFT element TrB and the other end is connected to the common electrode COM and grounded. One end of the storage capacitor CsB is connected to the drain of the TFT element TrB and the other end is connected to the storage capacity line CSL. The gate lines GCLA and GCLB are connected to the gate driver 52, and the data line SGL is connected to the data driver 53.

As shown in FIG. 5B, the display part 20 has a liquid crystal layer 203 sealed between a drive substrate 207 and an opposite substrate 208. The drive substrate 207 includes a transparent substrate 201, a pixel electrode 202, and a polarization plate 206a. The transparent substrate 201 is typically composed of glass or the like and carries the TFT elements Tr. On the transparent substrate 201, the pixel electrode 202 typically formed by ITO (indium tin oxide) is mounted. The pixel electrode 202 is provided for each of the sub-pixel segments PA and PB, and is supplied with a pixel signal from the data driver 53 via the TFT elements TrA and TrB. The pixel electrode 202 is covered with an oriented film, not shown. The polarization plate 206a is pasted on that surface of the transparent substrate 201 opposite to the surface bearing the pixel electrode 202 and other components. The opposite substrate 208 includes a transparent substrate 205, a counter electrode 204 (common electrode COM), and a polarization plate 206b. Like the transparent substrate 201, the transparent substrate 205 is typically composed of glass or the like. Furnished on the surface of the transparent substrate 205 facing the liquid crystal layer 203 are color filters and a black matrix, not shown. Formed on top of these components is the counter electrode 204 composed of ITO or the like. The counter electrode 204 is an electrode common to the pixels Pix and supplied typically with 0 V. Further provided on top of the counter electrode 204 is an oriented film, not shown. The polarization plate 206b is pasted on that surface of the transparent substrate 205 opposite to the surface bearing the counter electrode 204 and other components. The polarization plates 206a and 206b are pasted together to form crossed Nicols.

The liquid crystal layer 203 can change its light transmittance T depending on the orientation direction. For example, the liquid crystal layer 203 contains liquid crystal molecules M having negative dielectric constant anisotropy. The liquid crystal molecules M are vertically aligned by oriented films. That is, the liquid crystal layer 203 functions as so-called VA (vertical alignment) liquid crystal. In this example, the liquid crystal layer 203 undergoes so-called half-tone drive upon normal display (two-dimensional display). This allows the three-dimensional display device 1 to minimize the deterioration of its view angle characteristic, as will be discussed later.

The display part 20 has a so-called multi-domain structure, to be discussed later. That is, the display part 20 has a plurality of domains (domains D1 and D2, to be explained later) in each of the sub-pixel segments PA and PB, the domains being structured to have their liquid crystal molecules M oriented in different directions. This makes it possible for the three-dimensional display device 1 to suppress the deterioration of its view angle characteristic, as will be described later.

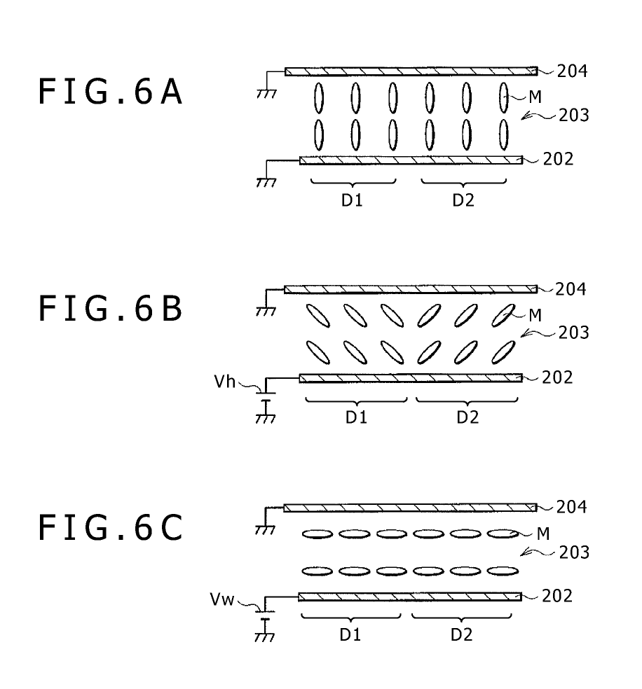

FIGS. 6A, 6B and 6C show orientations of the liquid crystal molecules M in the liquid crystal layer 203. FIG. 6A shows the case in which the pixel signal of 0 V is applied to the pixel electrode 202; FIG. 6B shows the case in which the pixel signal of a voltage Vh is applied to the pixel electrode 202, and FIG. 6C shows the case in which the pixel signal of a voltage Vw higher than the voltage Vh is applied to the pixel electrode 202. For example, the voltage Vh is about 4 V and the voltage Vw is about 8 V.

When the pixel signal of 0 V is applied to the pixel electrode 202, the liquid crystal molecules M are oriented so that their major axis becomes perpendicular to the substrate surface, as shown in FIG. 6A. Where the liquid crystal molecules M of the sub-pixel segments PA and PB are oriented in this manner, the light transmittance of these segments is made sufficiently low to provide black display.

When the pixel signal of the voltage Vw is applied to the pixel electrode 202, the liquid crystal molecules M are oriented so that their major axis becomes parallel to the substrate surface, as shown in FIG. 6C. Where the liquid crystal molecules M of the sub-pixel segments PA and PB are oriented in this manner, the light transmittance of these segments is made high to provide so-called white display.

When the pixel signal of the voltage Vh is applied to the pixel electrode 202, the liquid crystal molecules M are oriented so that their major axis is inclined at an angle between the orientation shown in FIG. 6A and the orientation in FIG. 6C, as shown in FIG. 6B. In this case, as illustrated in FIG. 6B, the liquid crystal molecules M in the left-side domain D1 and in the right-side domain D2 are inclined in different directions but to about the same extent (i.e., at about the same angle). Where the liquid crystal molecules M in the sub-pixel segments PA and PB are oriented in this manner, the sub-pixel segments PA and PB have their light transmittance brought to a medium degree thereby providing half-tone display.

As described, when the pixel signal is applied to the pixel electrode 202 of the sub-pixel segments PA and PB in the display part 20, the liquid crystal layer 203 has its liquid crystal oriented in accordance with the voltage of the pixel signal. This allows the sub-pixel segments PA and PB to give display independent of each other.

(Barrier Part 10)

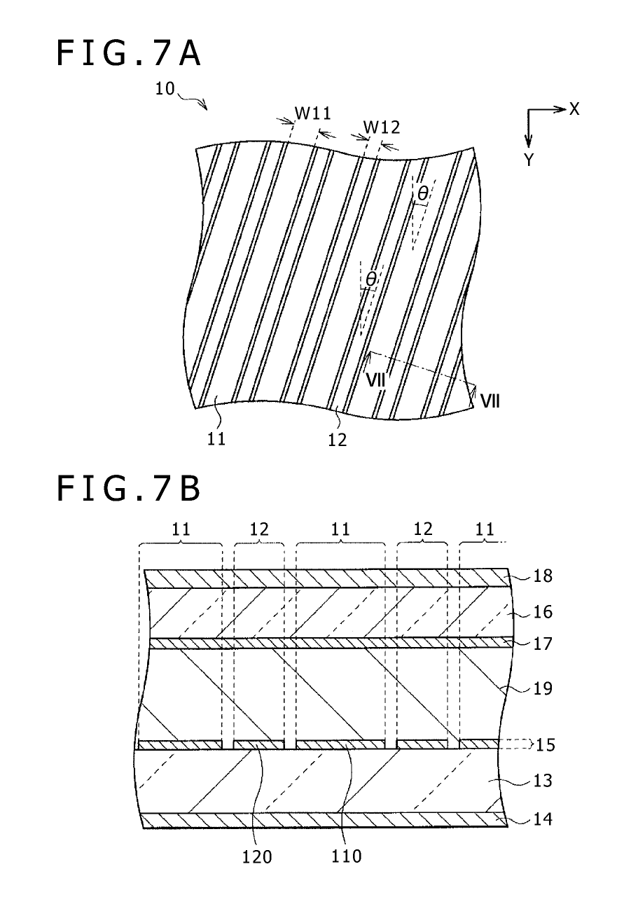

FIGS. 7A and 7B show a typical structure of the barrier part 10. FIG. 7A is a plan view of the barrier part 10, and FIG. 7B shows a cross-sectional structure of the barrier part 10, taken on line VII-VII of FIG. 7A.

The barrier part 10 is made up of so-called parallax barriers. As shown in FIG. 7A, the barrier part 10 has a plurality of opening/closing portions (liquid crystal barriers) 11 and 12 that let pass or block light. The opening/closing portions 11 and 12 are disposed extended in one direction on the X-Y plane (at a predetermined angle θ from the vertical direction Y for example). In this example, the opening/closing portion 11 has a width W11 different from the width W12 of the opening/closing portion 12. For example, the width W11 is greater than the width W12 (W11>W12). However, this is not limitative of the relation in width between the opening/closing portions 11 and 12. Alternatively, the relation in width between the opening/closing portions 11 and 12 may be W11<W12 or W11=W12.

The barrier part 10 typically has a liquid crystal layer 19 interposed between transparent substrates 13 and 16 made of glass or the like, as shown in FIG. 7B. In this example, the transparent substrate 13 is positioned on the side of the light-incident side and the transparent substrate 16 is located on the light-exit side. The surfaces of the transparent substrates 13 and 16 on the side of the liquid crystal layer 19 are furnished with transparent electrode layers 15 and 17, respectively, each layer made of ITO or the like. The surfaces of the transparent electrode layers 15 and 17 on the side of the liquid crystal layer 19 are each furnished with an oriented film, not shown. Polarization plates 14 and 18 are pasted to form crossed Nicols on the light-incident side of the transparent substrate 13 and on the light-exit side of the transparent substrate 16, respectively.

The transparent electrode layer 15 has a plurality of transparent electrodes 110 and 120. The transparent electrode layer 17 is furnished as an electrode common to the opening/closing portions 11 and 12. In this example, the voltage of 0 V is applied to the transparent electrode layer 17. The transparent electrode 110 and those portions of the electrode layer 19 and transparent electrode layer 17 which correspond to the transparent electrode 110 make up the opening/closing portions 11. Likewise, the transparent electrode 120 and those portions of the electrode layer 19 and transparent electrode layer 17 which correspond to the transparent electrode 120 constitute the opening/closing portions 12.

The above-described structure allows the barrier part 10 to apply voltages selectively to the transparent electrode 110 or 120. This enables the liquid crystal layer 19 to orient its liquid crystal in keeping with the applied voltage, thereby causing the opening/closing portions 11 and 12 to perform opening and closing operations individually.

The opening/closing portions 11 and 12 operate differently depending on whether the three-dimensional display device 1 performs normal display (two-dimensional display) or three-dimensional display. Specifically, the opening/closing portions 11 are opened (transparent state) upon normal display and closed (blocked state) upon three-dimensional display, as will be discussed later. The opening/closing portions 12 are opened (transparent state) upon both normal display and three-dimensional display, as will be explained later.

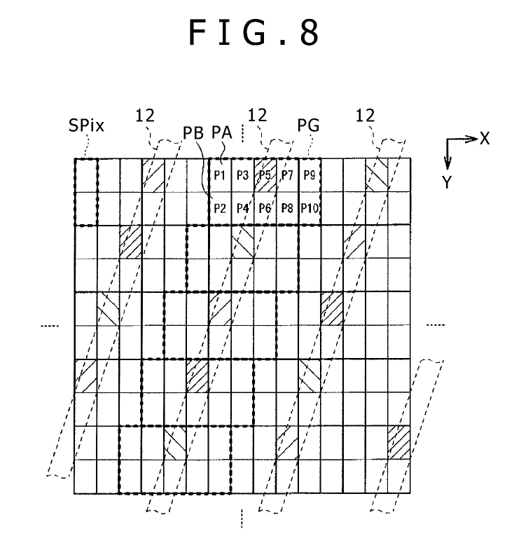

FIG. 8 shows the positional relation between the sub-pixels SPix of the display part 20 on the one hand and the opening/closing portions 12 of the battier part 10 on the other hand. In this example, one opening/closing portion 12 is provided for every five sub-pixels SPix (that make up a sub-pixel group PG) arrayed adjacent to each other in the horizontal direction X. Upon three-dimensional display, the display part 20 displays pixel information items P1 through P10 about ten perspective images using the five sub-pixel segments PA and five sub-pixel segments PB in one sub-pixel group PG. In FIG. 8, only the sub-pixel segments PA displaying the pixel information item P5 are shown hatched for purpose of explanation.

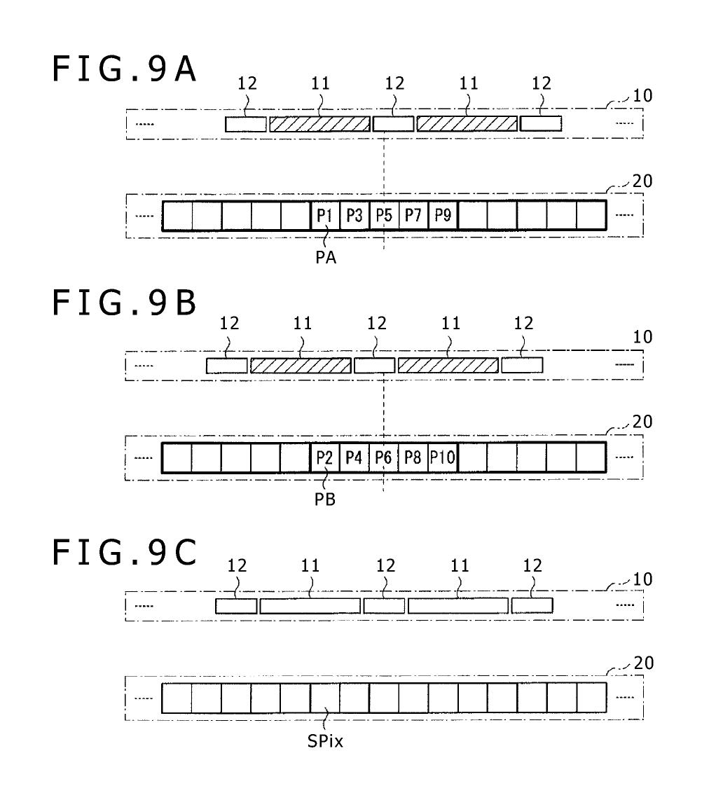

FIGS. 9A, 9B and 9C schematically show, using cross-sectional structures, how the barrier part 10 works upon three-dimensional display and upon normal display (two-dimensional display). FIGS. 9A and 9B show what takes place upon three-dimensional display, and FIG. 9C shows what occurs upon normal display. FIG. 9A shows a three-dimensional display provided by a row of the sub-pixel segments PA as part of the sub-pixel segments PA and PB indicated in FIG. 8. FIG. 9B shows a three-dimensional display provided by a row of the sub-pixel segments PB. In FIGS. 9A and 9B, the shaded opening/closing portions 11 indicate that light is being blocked thereby.

When three-dimensional display is performed, the image signal S3D is supplied to the display drive part 50 so that the display part 20 gives its display based on the supplied signal. Specifically, in the barrier part 10, the opening/closing portions 12 are opened (transparent state) and the opening/closing portions 11 are closed (blocked state) as shown in FIGS. 9A and 9B. The display part 20 allows the five sub-pixel segments PA and five sub-pixel segments PB which are arrayed adjacent to each other and which correspond positionally to the opening/closing portions 12 to display sub-pixel information items P1 through P10 corresponding to ten perspective images, respectively. In turn, the observer can view a three-dimensional image by observing different perspective images with his or her right and left eyes, as will be discussed later.

When normal display (two-dimensional display) is carried out, the image signal S2D is supplied to the display drive part 50 so that the display part 20 gives its display based on the supplied signal. Specifically, in the barrier part 10, the opening/closing portions 11 and 12 are opened (transparent state) as shown in FIG. 9C. The display part 20 allows all sub-pixels SPix to display the pixel information about one perspective image (two-dimensional image). This allows the observer directly to view a normal two-dimensional image displayed on the display part 20.

Incidentally, the sub-pixels SPix are an example of the “pixels” described in the present disclosure, and the sub-pixel segments PA and PB are an example of the “segments” also described in the present disclosure. The mode in which three-dimensional display is performed is an example of the “first display mode” and the mode in which normal display (two-dimensional display) is carried out is an example of the “second display mode,” both modes described in the present disclosure. The LUT's 54A and 54B are an example of the “intensity correction tables” described in the present disclosure. The opening/closing portions 12 are an example of the “first-group liquid crystal barriers” and the opening/closing portions 11 are an example of the “second-group liquid crystal barriers,” also described in the present disclosure.

[Operations and Functions]

Explained below are the operations and functions of the three-dimensional display device 1 as the first embodiment of the present disclosure.

(Overall Operations)

The overall operations of the three-dimensional display device 1 are first outlined below by reference to FIG. 1 and other drawings. Based on the externally supplied image signal Sdisp, the control part 41 controls the backlight drive part 42, display drive part 50, and barrier drive part 43. The backlight drive part 42 drives the backlight part 30 based on the backlight control signal supplied from the control part 41. The backlight part 30 applies flat-emitted light to the display part 20. The display drive part 50 drives the display part 20 based on the image signal Sdisp2 supplied from the control part 41. The display part 20 provides display by modulating the light coming from the backlight part 30. Specifically, upon normal display (two-dimensional display), the display part 20 allows the sub-pixels SPix to display the pixel information about one perspective image (two-dimensional image). Upon three-dimensional display, the display part 20 allows the five sub-pixel segments PA and five sub-pixel segments PB in each sub-pixel group PG to display the pixel information about ten perspective images. The barrier drive part 43 controls the barrier part 10 based on the barrier control signal supplied from the control part 41. The opening/closing portions 11 and 12 in the barrier part 10 perform opening and closing operations under instructions from the barrier drive part 43, thereby letting pass or blocking the light coming from the backlight part 30 past the display part 20.

(Detailed Operations)

The detailed operations to be performed upon normal display (two-dimensional display) are explained first. When normal display is carried out, the opening/closing portions 11 and 12 in the barrier part 10 are opened (transparent state). The display part 20 allows the sub-pixels SPix to display the pixel information about one perspective image (two-dimensional image). At this point, the timing control portion 51 performs gamma correction on one pixel information item (intensity information) differently using the LUT's 54A and 54B. The data driver 53 supplies the pixel signal generated using the LUT 54A to the sub-pixel segment PA of a given sub-pixel SPix and the pixel signal generated using the LUT 54B to the sub-pixel segment PB of that sub-pixel SPix. The display part 20 allows the sub-pixel segments PA and PB to execute display based on these pixel signals, thereby implementing display based on that one pixel information item.

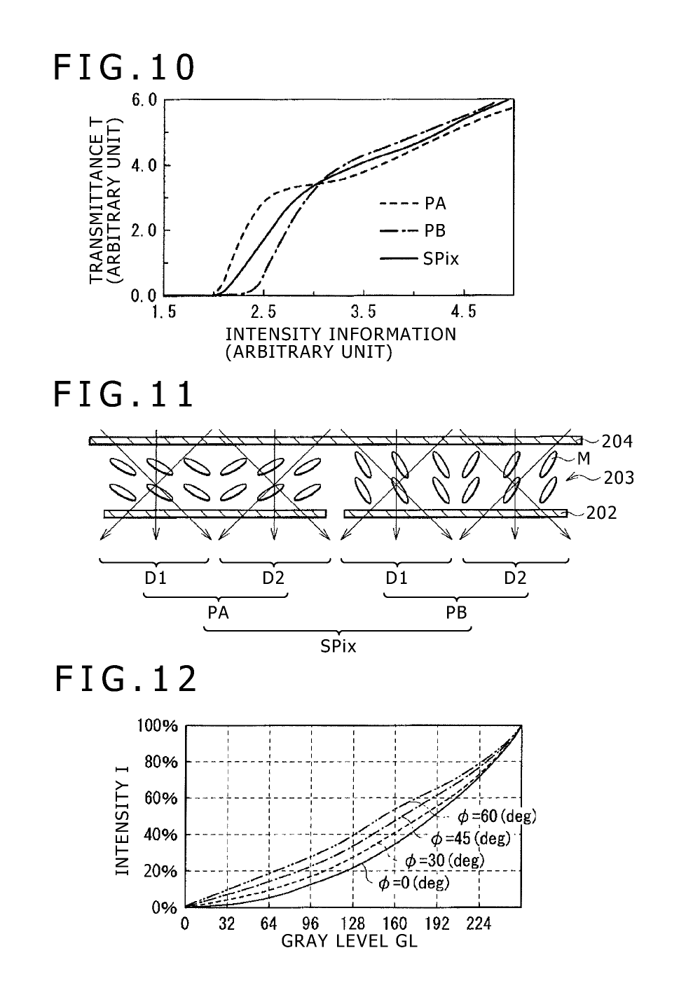

FIG. 10 shows the display characteristics of the sub-pixels SPix upon normal display. In FIG. 10, the horizontal axis represents intensity information and the vertical axis denotes light transmittance T. Also in FIG. 10, a broken line stands for the characteristic of the sub-pixel segment PA, a dashed line for the characteristic of the sub-pixel segment PB, and a solid line for the characteristic of the entire sub-pixel SPix including the sub-pixel segments PA and PB.

As shown in FIG. 10, the sub-pixel segments PA and PB have different display characteristics. Specifically, when intensity information is increasing, the light transmittance of the sub-pixel segment PA starts going up first, followed by the light transmittance of the sub-pixel segment PB. That is, the display part 20 is driven so that in the so-called half-tone state, the liquid crystal molecules M of the sub-pixel segment A and the liquid crystal molecules M of the sub-pixel segment B are oriented in different directions. In this case, the light transmittance characteristic of the entire sub-pixel SPix including the sub-pixel segments PA and PB becomes an intermediate characteristic between the characteristic of the sub-pixel segment PA and that of the sub-pixel segment PB, as shown in FIG. 10. The change in the transmittance T when intensity information is on the increase thus becomes less steep.

As described, the display part 20 can minimize the deterioration of its view angle characteristic because it is driven in such a manner that in the half-tone state, the liquid crystal molecules M of the sub-pixel segment A and the liquid crystal molecules M of the sub-pixel segment B are oriented in different directions. More details about this are explained below.

FIG. 11 shows the orientation of the liquid crystal molecules M in the half-tone state. Generally, the liquid crystal display device changes light transmittance depending on the relative relations between the direction in which the observer observes and the direction in which the major axis of liquid crystal molecules M is aligned. Specifically, in the example of FIG. 11, when the observer observes from top left of the domain D1, the transmittance T is low because the direction of observation is approximately the same as the direction in which the major axis of the liquid crystal molecules M is aligned. On the other hand, when the observer observes from top right of the domain D1, the transmittance T is high because the direction of observation is considerably different from the direction in which the major axis of the liquid crystal molecules M is aligned. Likewise, when the observer observes from top right of the domain D2, the transmittance T is low because the direction of observation is approximately the same as the direction in which the major axis of the liquid crystal molecules M is aligned. When the observer observes from top left of the domain D2, the transmittance T is high because the direction of observation is considerably different from the direction in which the major axis of the liquid crystal molecules M is aligned. In this case, unlike the comparative example to be discussed later, the display part 20 includes the sub-pixel segments PA and PB and allows each segment to orient its liquid crystal molecules M in different directions. This arrangement reduces the changes in transmittance T that vary depending on the direction of observation.

FIG. 12 shows typical view angle characteristics of the display part 20. The view angle characteristics shown in FIG. 12 are obtained by observing the intensity I of display from several directions of observation (at observation angles φ). Here, the observation angle φ refers to an angle (polar angle) relative to the normal direction of the display screen. For example, if the observation angle φ is 0 [deg], that means the observer observes the display screen from the front; if the observation angle φ is 60 [deg], that means the observer observes the display screen at an angle of 60 [deg] relative to the normal direction of the screen.

As shown in FIG. 12, the transmittance T of the liquid crystal layer 203 is high and the intensity is on the increase when the observer observes the display part 20 obliquely. Here, since the display part 20 has the sub-pixel segments PA and PB with their liquid crystal molecules M oriented in different directions, the display part 20 gives smaller changes in intensity I than the comparative example (to be discussed later) when the observation angle φ is varied. In other words, the display part 20 reduces the difference in vision between when the observer observes the display screen from the front and when the observer observes the display screen aslant, thereby implementing a wide view angle.

The detailed operations to be performed upon three-dimensional display are explained next. When three-dimensional display is carried out, the timing control portion 51 performs gamma correction on the pixel information (intensity information) about different perspective images using the LUT's 54A and 54B, respectively. The data driver 53 supplies the pixel signal generated using the LUT 54A to the sub-pixel segment PA of a given sub-pixel SPix and the pixel signal generated using the LUT 54B to the sub-pixel segment PB of that sub-pixel SPix. The display part 20 allows the sub-pixel segments PA and PB to display pixel information about the different perspective images based on such pixel information.

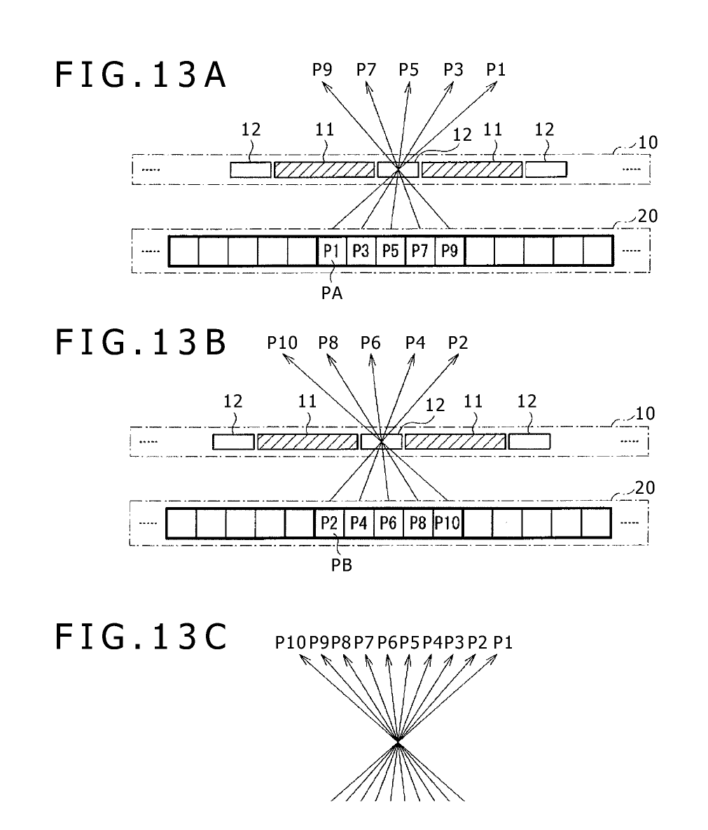

FIGS. 13A, 13B and 13C show the typical workings of three-dimensional display performed by the three-dimensional display device 1. FIG. 13A shows how the display is provided by a row of the sub-pixel segments PA. FIG. 13B shows how the display is provided by a row of the sub-pixel segments PB. FIG. 13C schematically shows how the display is provided by the entire sub-pixel group PG.

When three-dimensional display is performed, the opening/closing portions 12 are opened (transparent state) and the opening/closing portions 11 are closed (blocked state) in the barrier part 10. The display part 20 allows five sub-pixel segments PA disposed near the opening/closing portions 12 to display pixel information items P1, P3, P5, P7 and P9 (FIG. 13A) and five sub-pixel segments PB disposed near the opening/closing portions 12 to display pixel information items P2, P4, P6, P8 and P10 (FIG. 13B). The light beams leaving the sub-pixel segments PA and PB of the display part 20 have their angles restricted by the opening/closing portions 12 when output. Here, as shown in FIG. 8, the positions of the opening/closing portions 12 relative to the sub-pixel segments PA deviate from their positions relative to the sub-pixel segments PB because the opening/closing portions 12 extend slantwise. For example, the light beam associated with the pixel information item P1 advances in a direction different from the direction in which the light beam associated with the pixel information item P2 advances, as shown in FIGS. 13A and 13B. In this manner, the light beams associated with the pixel information items P1 through P10 leaving the sub-pixel segments PA and PB advance in ten different directions. The observer may view the pixel information item P5 with the left eye and the pixel information item P6 with the right eye, for example. When the observer views different pixel information items from among the pixel information items P1 through P10 with his or her left eye and right eye, the observer can perceive the displayed images as a three-dimensional image.

(Comparative Example)

Explained next is a three-dimensional display device 1R as the comparative example. This comparative example constitutes a display part 20R that has sub-pixels SPixR devoid of sub-pixel segments PA and PB. The display part 20R is driven by a display drive part 50R, not shown, for each of the sub-pixels SPixR. The remaining structures of the comparative example are the same as their counterparts of the first embodiment (FIG. 1).

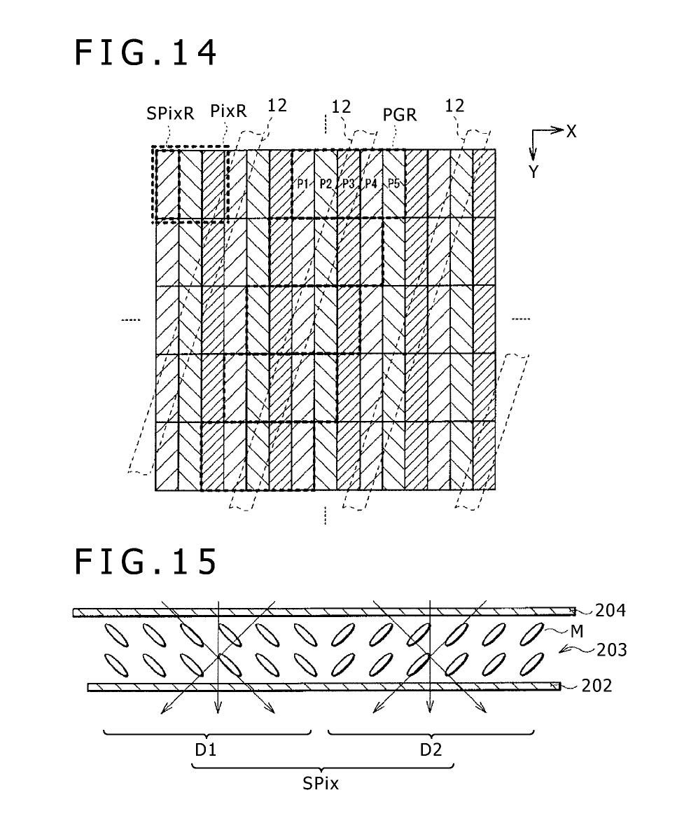

FIG. 14 shows a typical structure of the display part 20R of the three-dimensional display device 1R. The display part 20R has its pixels PixR arranged in a matrix pattern, each of the pixels having three sub-pixels SPixR corresponding to the colors of red (R), green (G) and blue (B). Unlike the sub-pixels SPix of the first embodiment, the sub-pixels SPixR of the comparative example do not have the sub-pixel segments PA and PB each. In the three-dimensional display device 1R, one opening/closing portion 12 is provided for every five sub-pixels SPixR (making up the sub-pixel group PGR) arrayed adjacent to one another in the horizontal direction X. The size of the sub-pixel group PGR is the same as that of the sub-pixel group PG (FIG. 8) of the first embodiment.

Explained first is what takes place when normal display (two-dimensional display) is performed.

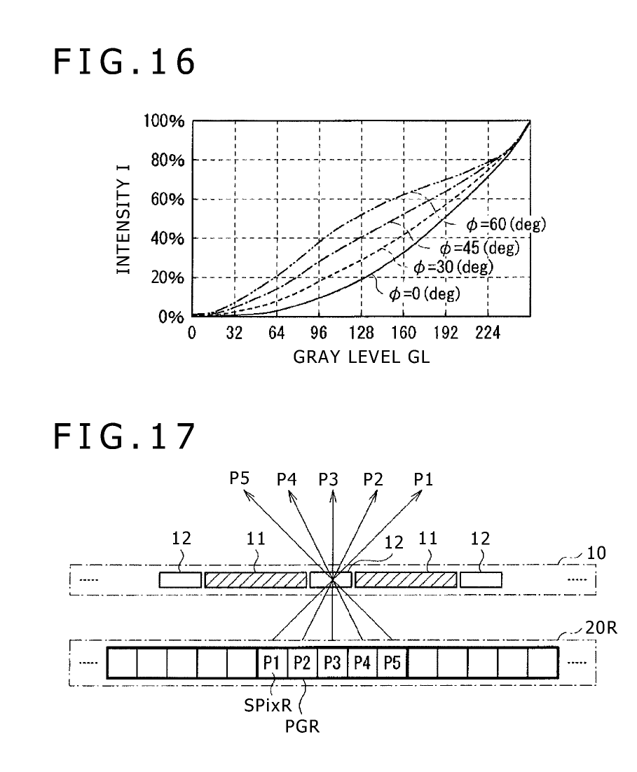

FIG. 15 shows how the liquid crystal molecules M of a sub-pixel SPixR are oriented in the half-tone state. FIG. 16 shows typical view angle characteristics of the display part 20R of the comparative example. In the half-tone state, as with the first embodiment (FIGS. 11 and 12), the liquid crystal layer 203 provides high transmittance T and high intensity when observed slantwise by the observer. Here, the display part 20R of the comparative example has the liquid crystal molecules M in each sub-pixel SPixR inclined at approximately the same angle. That means transmittance T may possibly be changed significantly when observed from different directions. In this case, as shown in FIG. 16, there may occur appreciable changes in intensity I at different observation angles φ.

Meanwhile, the three-dimensional display device 1 of the first embodiment includes the sub-pixel segments PA and PB in each sub-pixel SPix, as shown in FIG. 11. The liquid crystal molecules M of the sub-pixel segments PA and those of the sub-pixel segments PB can thus be inclined at different angles, so that the transmittance T can average out through the sub-pixel segments PA and PB. This in turn reduces the differences in transmittance T between different directions of observation and minimizes the changes in intensity I at different observation angles φ as shown in FIG. 12, whereby a wide view angle is implemented.

What takes place when three-dimensional display is performed is explained next.

FIG. 17 shows the typical workings of three-dimensional display carried out by the three-dimensional display device 1R of the comparative example. In performing three-dimensional display, the three-dimensional display device 1R allows five sub-pixels SPixR disposed near each opening/closing portion 12 to display pixel information items P1 through P5 about five perspective images. That is, the three-dimensional display device 1R displays five perspective images.

Meanwhile, the three-dimensional display device 1 of the first embodiment includes the sub-pixel segments PA and PB in each sub-pixel SPix and allows the segments to be driven independently, thereby doubling the number of perspective images that may be displayed (10=5×2). Also, since the size of the sub-pixel group PG (FIG. 8) of the first embodiment is the same as the size of the sub-pixel group PGR (FIG. 14) of the comparative example, the resolution of three-dimensional display is the same for both the first embodiment and the comparative example. That is, compared with the three-dimensional display device 1R of the comparative example, the three-dimensional display device 1 of the first embodiment can increase the number of perspective images that may be displayed while maintaining the resolution of display.

[Effects]

As described, the first embodiment of the disclosure includes in each sub-pixel two sub-pixel segments PA and PB that can execute display independently. This makes it possible upon three-dimensional display to display different perspective images, minimize the drop in resolution, and increase the number of perspective images to be displayed thereby improving image quality.

Also, the first embodiment upon normal display allows the sub-pixel segments PA and PB to display pixel information items each subjected to different gamma correction. This arrangement implements a wide view angle and enhances image quality.

[Variation 1-1]

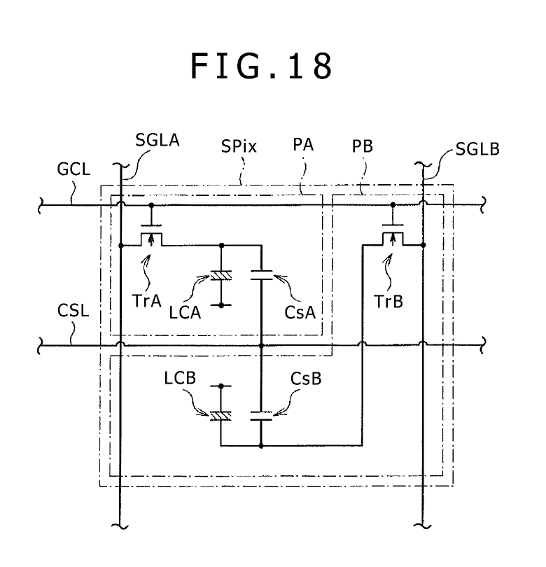

With the first embodiment, the data line SGL for supplying the pixel signal is shared by two sub-pixel segments PA and PB as shown in FIGS. 5A and 5B, but this is not limitative. Alternatively, as shown in FIG. 18, a gate line GCL may be shared by two sub-pixel segments PA and PB. In the sub-pixel segment PA, the gate and source of the TFT element TrA are connected to the gate line GCL and a data line SGLA, respectively. The drain of the TFT element TrA is connected to one end of the liquid crystal element LCA and to one end of the storage capacitor CsA. Likewise, in the sub-pixel segment PB, the gate and source of the TFT element TrB are connected to the gate line GCL and a data line SGLB, respectively. The drain of the TFT element TrB is connected to one end of the liquid crystal element LCB and to one end of the storage capacitor CsB. The gate line GCL is connected to a gate driver 52A (not shown), and the data lines SGLA and SGLB are connected to a data driver 53A (not shown).

[Variation 1-2]

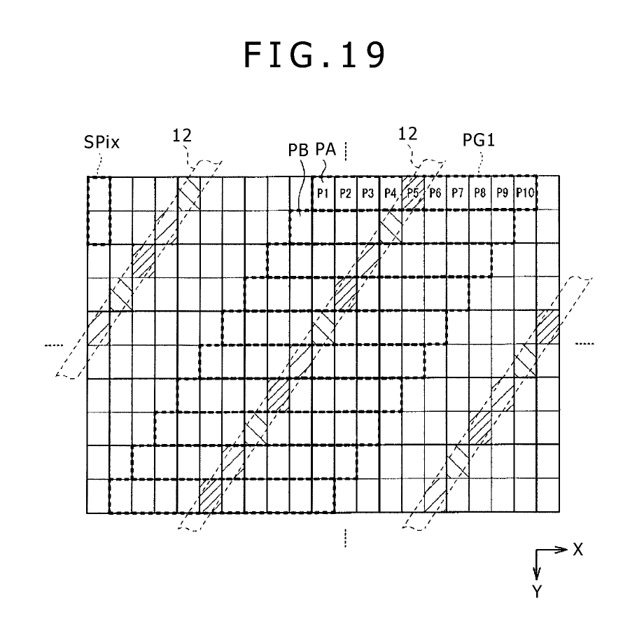

In the first embodiment discussed above, five sub-pixels SPix (i.e., five sub-pixel segments PA and five sub-pixel segments PB) make up one sub-pixel group PG, but this is not limitative. Alternatively, as shown in FIG. 19, either ten sub-pixel segments PA or ten sub-pixel segments PB may constitute one sub-pixel group PG1.

[Variation 1-3]

In the above-described first embodiment, the sub-pixel segments PA and PB in each sub-pixel SPix are arrayed in the vertical direction Y, but this is not limitative. Alternatively, the sub-pixel segments PA and PB may be arrayed in the horizontal direction X. More details of this variation are explained below.

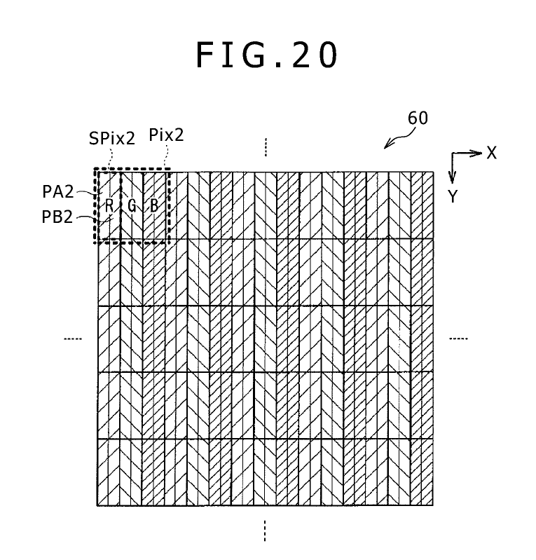

FIG. 20 shows an array of pixels Pix2 on a display part 60 of this variation. Each pixel Pix2 has three sub-pixels SPix2 corresponding to the colors of red (R), green (G) and blue (B). Each sub-pixel SPix2 has sub-pixel segments PA2 and PB2. In this example, the sub-pixel segments PA2 and PB2 in each sub-pixel SPix2 are arrayed in the horizontal direction X.

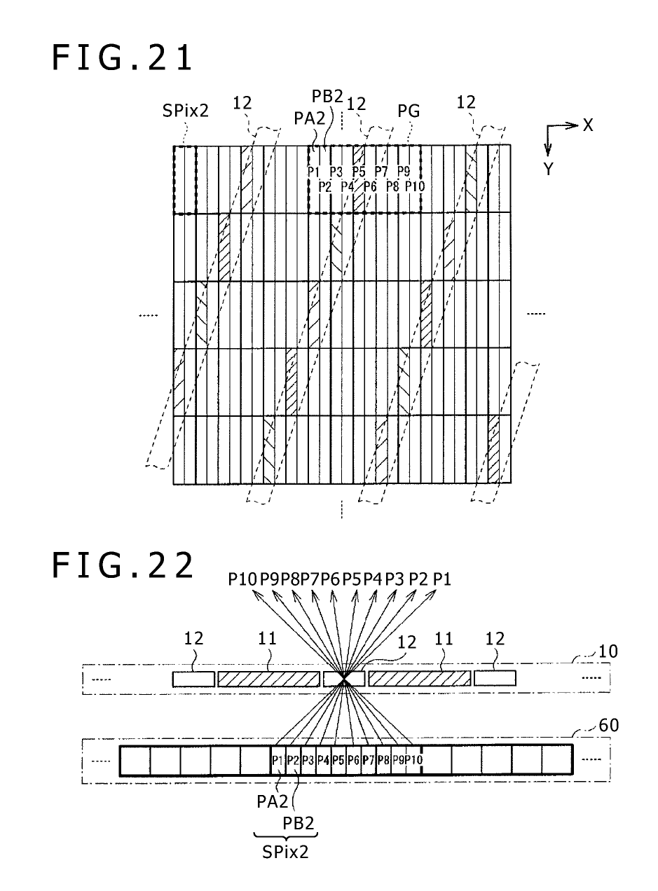

FIG. 21 shows the positional relation between the sub-pixels SPix2 of the display part 60 on the one hand and the opening/closing portions 12 of the barrier part 10 on the other hand. In this example, one opening/closing portion 12 is provided for every five sub-pixels SPix2 (making up a sub-pixel group PG) disposed adjacent to one another in the horizontal direction X. When three-dimensional display is performed, the display part 60 allows the five sub-pixel segments PA2 and five sub-pixel segments PB2 in each sub-pixel group PG to display pixel information items P1 through P10 about ten perspective images.

When normal display (two-dimensional display) is carried out, the sub-pixel segments PA2 and PB2 associated with one sub-pixel SPix2 give display based on different pixel information items about one perspective image (two-dimensional image) as with the three-dimensional display device 1 of the first embodiment discussed above.

Explained next is what takes place upon three-dimensional display with the above variation.

FIG. 22 shows the typical workings of three-dimensional display performed by this variation. The display part 60 allows ten sub-pixel segments PA2 and PB2 disposed near each opening/closing portion 12 in the opened state (transparent state) to display pixel information items P1 through P10. The light beams leaving the sub-pixel segments PA2 and PB2 of the display part 60 have their angles restricted by the opening/closing portions 12 when output. The observer may view the pixel information item P5 with the left eye and the pixel information item P6 with the right eye, for example. When the observer views different pixel information items from among the pixel information items P1 through P10 with his or her left eye and right eye, the observer can perceive the displayed images as a three-dimensional image.

[Variation 1-4]

In the foregoing variation, each sub-pixel SPix is arranged to have two sub-pixel segments. Alternatively, each sub-pixel SPix may be arranged to have three or more sub-pixel segments.

[Variation 1-5]

In the above-described first embodiment, the opening/closing portions 11 and 12 capable of varying light transmittance are used to make up the barrier part 10, but this is not limitative. Alternatively, the barrier part 10 may be formed using fixed barriers of which those corresponding to the opening/closing portions 11 are closed to block light and of which those corresponding to the opening/closing portions 12 are opened to let pass light. In this case, three-dimensional display can also be carried out in substantially the same manner as with the above-described first embodiment (as shown in FIGS. 13A through 13C and others). For normal display (two-dimensional display), five sub-pixels SPix (sub-pixel group PG) disposed near each opening are allowed to display one pixel information item, whereby a two-dimensional image is displayed.

### 2. Second Embodiment

A three-dimensional display device 2 as a second embodiment of the present disclosure is explained below. The second embodiment is different from the first embodiment discussed above in terms of the sub-pixel group structure for three-dimensional display. That is, with the first embodiment (FIG. 8), ten sub-pixel segments PA and PB make up one sub-pixel group PG. With the second embodiment, by contrast, five sub-pixel segments PA or PB constitute one sub-pixel group PG3. The remaining structures of the second embodiment are the same as their counterparts of the first embodiment (FIG. 1 and others). Of the components making up the second embodiment, those substantially the same as their counterparts of the three-dimensional display device as the first embodiment will be designated by the same reference numerals, and their explanations will be omitted hereunder where redundant.

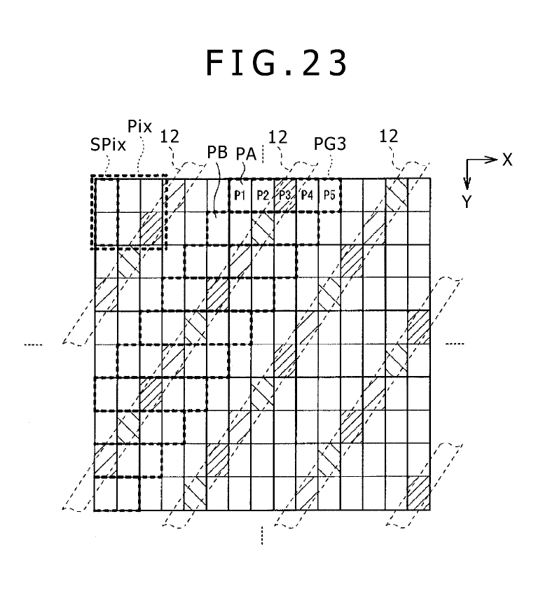

FIG. 23 shows a typical structure of a sub-pixel group PG3 in the display part 20 of the three-dimensional display device 2. The sub-pixel group PG3 is made up of five sub-pixel segments PA or five sub-pixel segments PB. The size of the sub-pixel group PG3 is half the size of the sub-pixel group PG (FIG. 8) of the first embodiment or half the size of the sub-pixel group PGR (FIG. 14) of the comparative example.

When normal display (two-dimensional display) is performed, the sub-pixel segments PA and PB in each sub-pixel SPix provide the display based on the pixel information items about one perspective image (two-dimensional image) as with the three-dimensional display device 1 of the first embodiment.

When three-dimensional display is carried out, the five sub-pixel segments PA or five sub-pixel segments PB in the sub-pixel group PG3 display pixel information items P1 through P5 about five perspective images. Here, because the size of the sub-pixel group PG3 (FIG. 23) of the second embodiment is half the size of the sub-pixel group PGR (FIG. 14) of the comparative example, the resolution of three-dimensional display can be made twice as high. That is, compared with the three-dimensional display device 1R of the comparative example, the three-dimensional display device 2 of the second embodiment can double the resolution of three-dimensional display while maintaining the number of perspective images that may be displayed.

With the second embodiment, as described above, five sub-pixel segments PA or PB constitute each sub-pixel group PG3. This makes it possible to improve resolution and thereby enhance image quality without reducing the number of perspective images to be displayed. The other effects of the second embodiment are the same those of the first embodiment discussed above.

[Variation 2-1]

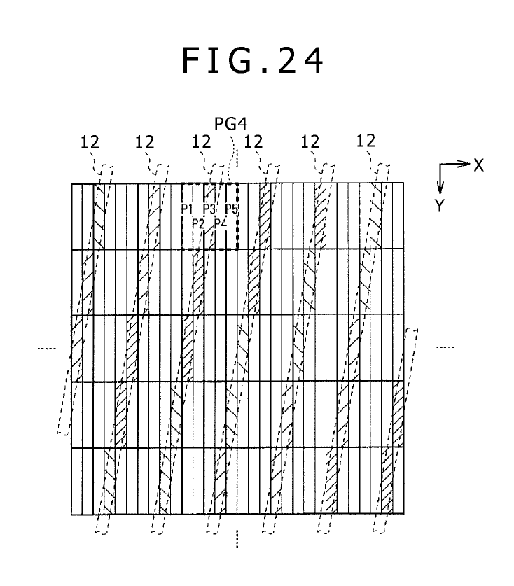

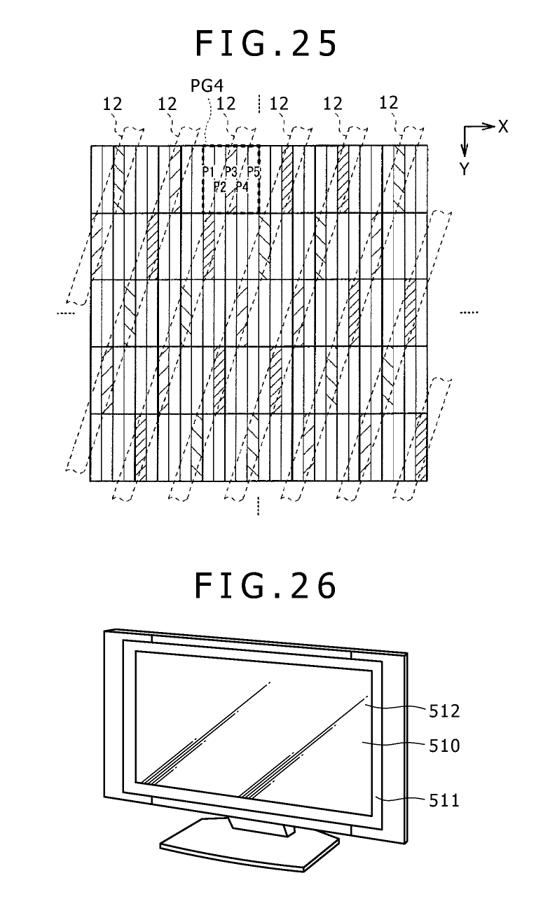

In the second embodiment, the sub-pixel group PG is changed using the five sub-pixel segments PA or PB in the display part 20 (FIG. 4) of the first embodiment, but this is not limitative. Alternatively, the sub-pixel group may be formed using five sub-pixel segments PA2 or PB2 of the display part 60 (FIG. 20) in the variation 1-3 of the first embodiment. Examples of this case are shown in FIGS. 24 and 25.

[Variation 2-2]

For example, the above-mentioned variations 1-1, 1-2, 1-4, and 1-5 of the first embodiment may be applied to the second embodiment as well.

### 3. Examples of Application

Explained below are some examples of application of the three-dimensional display device discussed above as the embodiments of the disclosure and their variations.

FIG. 26 shows an external structure of a TV set to which the three-dimensional display device embodying the present disclosure is applied. This TV set has an image display screen part 510 that includes a front panel 511 and a filter glass 512. The image display screen part 510 is constituted by the three-dimensional display device embodying the present disclosure as discussed above.

The three-dimensional display device as an embodiment of the disclosure may be applied not only to the TV set but also to a digital camera, a notebook-size personal computer, portable terminal equipment such as a mobile phone, a portable video game player, a video camera, or any other kind of electronic apparatus. In other words, the three-dimensional display device embodying this disclosure can be applied to all kinds of electronic apparatus that display images.

It is to be understood that while the disclosure has been described in conjunction with specific embodiments and their variations as well as with examples of application to electronic apparatus in reference to the accompanying drawings, it is evident that many alternatives, modifications and variations will become apparent to those skilled in the art in light of the foregoing description.

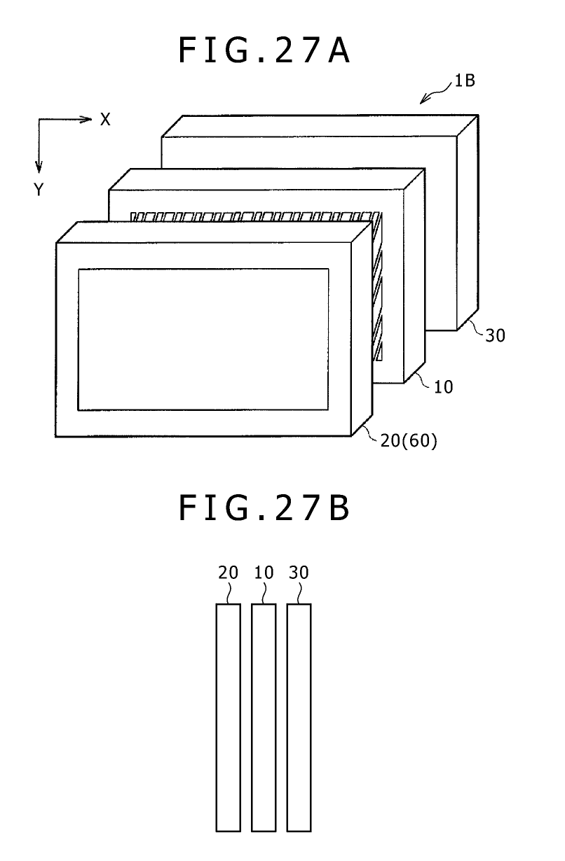

For example, although the backlight part 30, display part 20 (60), and barrier part 10 were described above as arrayed in that order in connection with the embodiments and their variations, this is not limitative of the present disclosure. Alternatively, the backlight part 30, barrier part 10, and display part 20 (60) may be arrayed in that order as shown in FIGS. 27A and 27B.

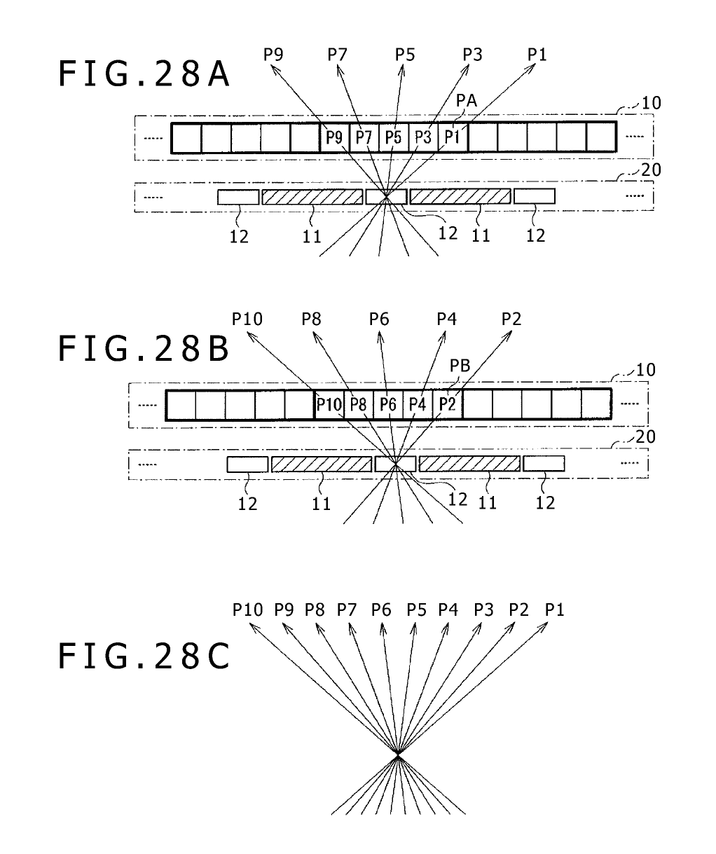

FIGS. 28A, 28B and 28C show the typical workings of three-dimensional display performed by the above variation of the three-dimensional display device 1 as the first embodiment. FIG. 28A shows how the display is provided by a row of the sub-pixel segments PA. FIG. 28B shows how the display is provided by a row of the sub-pixel segments PB. FIG. 28C schematically shows how the display is provided by the entire sub-pixel group PG. With this variation, the light leaving the backlight part 30 first enters the barrier part 10. Of the incident light beams, those past the opening/closing portions 12 are modulated by the display part 20 to output ten perspective images.

Also in connection with the embodiments and their variations discussed above, the opening/closing portions 12 were described as always opened for three-dimensional display. However, this is not limitative of the present disclosure. Alternatively, the opening/closing portions 12 may be divided into a plurality of groups driven to be opened and closed on a time-sharing basis therebetween. For example, if the opening/closing portions 12 are divided into two groups that are opened and closed alternately, the resolution of the three-dimensional display device can be made twice as high.

Also in connection with the first embodiment and its variations discussed above, the three-dimensional display device was described as displaying ten perspective images for three-dimensional display. However, this is not limitative of the present disclosure. Alternatively, 11 or more or fewer than ten perspective images may be displayed. Likewise, in connection with the second embodiment and its variations discussed above, the three-dimensional display device was described as displaying five perspective images. However, this is not limitative of the present disclosure. Alternatively, six or more or fewer than five perspective images may be displayed.

Also in connection with the embodiments discussed above, the three-dimensional display device was described as a parallax barrier type display device. However, this is not limitative of the present disclosure. Alternatively, a lenticular lens type three-dimensional display device may be devised. More details about this type of three-dimensional display device are explained below.

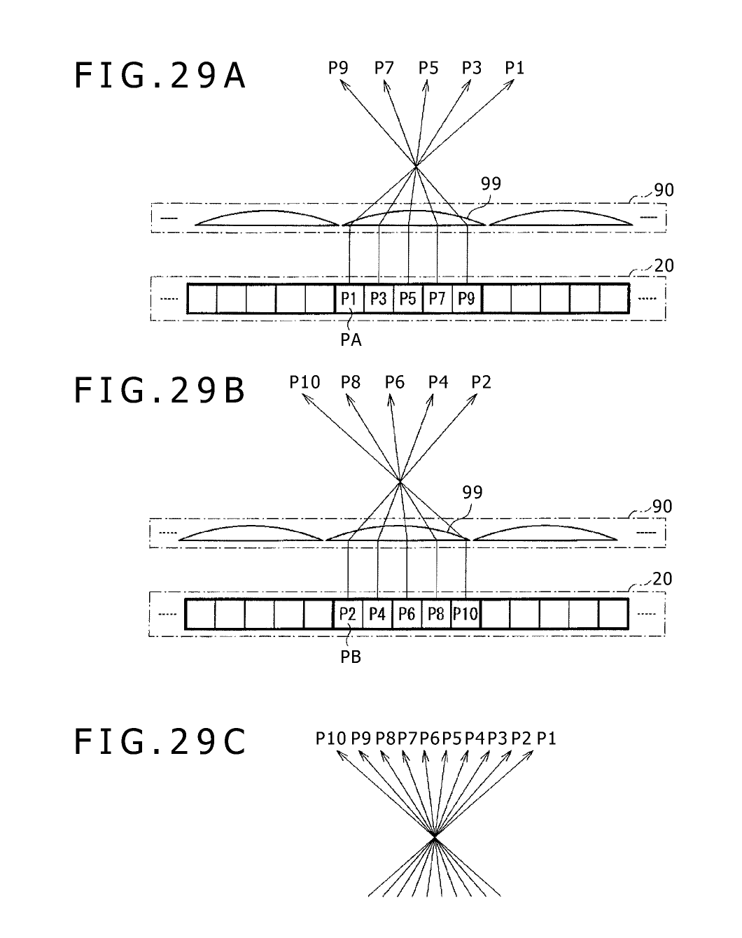

FIGS. 29A, 29B and 29C show the typical workings of three-dimensional display performed by a three-dimensional display device 3 devised by modifying the three-dimensional display device 1 of the first embodiment into a lenticular lens type display device. FIG. 29A shows how the display is provided by a row of sub-pixel segments PA. FIG. 29B shows how the display is provided by a row of sub-pixel segments PB. FIG. 29C schematically shows how the display is provided by the entire sub-pixel group PG. The three-dimensional display device 3 has a lens part 90 that includes a plurality of lenses 99 refracting the light coming from the backlight part 30 past the display part 20. When three-dimensional display is performed, the display part 20 allows ten sub-pixel segments PA and PB (making up the sub-pixel group PG) disposed in the positions corresponding to the lenses 99 to display pixel information items P1 through P10 corresponding to ten perspective images. The light beams leaving the sub-pixel segments PA and PB of the display part 20 are refracted by the lenses 99 for output in the respective directions.

The lenses 99 may each be shaped to have a fixed refractive index. Alternatively, each of the lenses 99 may be a liquid crystal lens or a liquid lens variable in refractive index and/or other characteristics.

In connection with the embodiments discussed above, the disclosed technology was described using the three-dimensional display device as an example, this is not limitative. Alternatively, the technology may be applied to a multiple display device. Multiple display involves displaying a plurality of images for a plurality of observers instead of displaying a plurality of perspective images for one observer. For example, a multiple display device may be implemented by making the image to be observed from the left side of the display screen front different from the image to be observed from the right side of the screen front.

The technology disclosed herein may be configured as follows:

(1) A display device including:
a liquid crystal display part configured to have an array of pixels each including a plurality of segments each driven independently, and
a light control part configured to control light coming from or directed to the liquid crystal display part;
wherein, in a first display mode provided by the display device, a plurality of pixel signals derived from different items of pixel information are supplied respectively to the plurality of segments in each of the pixels.
(2) The display device described in paragraph (1) above, wherein the different items of pixel information correspond to different perspective images.
(3) The display device described in paragraph (1) above, wherein the different items of pixel information are in different positions corresponding to either the same perspective image or different perspective images.
(4) The display device described in any one of paragraphs (1) through (3) above, further including a display drive part configured to have a plurality of intensity correction tables corresponding respectively to the plurality of segments in each of the pixels, the display drive part driving the liquid crystal display part by correcting the pixel information using the plurality of intensity correction tables.
(5) The display device described in paragraph (4) above, wherein the plurality of intensity correction tables are equivalent to each other, and the display drive part generates a pixel signal based on the pixel information corresponding to each of the segments.
(6) The display device described in paragraph (4) or (5) above, wherein, in a second display mode provided by the display device, the plurality of intensity correction tables are different from one another, and the display drive part generates a pixel signal based on the pixel information corresponding to each of the pixels.
(7) The display device described in paragraph (6) above, wherein the light control part constitutes a barrier part configured to let pass or block light, and the barrier part has a plurality of first-group liquid crystal barriers and a plurality of second-group liquid crystal barriers of which an opened state and a closed state may be switched.
(8) The display device described in paragraph (7) above, wherein, in the first display mode, the plurality of first-group liquid crystal barriers are turned into a transparent state and the plurality of second-group liquid crystal barriers are turned into a blocked state to display a plurality of perspective images, and in the second display mode, the plurality of first-group liquid crystal barriers and the plurality of second-group liquid crystal barriers are turned into the transparent state to display one perspective image.
(9) The display device described in any one of paragraphs (1) through (6) above, wherein the light control part constitutes a barrier part configured to let pass or block light, and
the barrier part has a plurality of fixed openings.
(10) The display device described in any one of paragraphs (1) through (6) above, wherein the light control part has a plurality of variable lenses of which the refractive index can be switched.
(11) The display device described in any one of paragraphs (1) through (6) above, wherein the light control part has a plurality of fixed lenses.
(12) The display device described in any one of paragraphs (1) through (11) above, wherein the plurality of segments are vertically arrayed in each of the pixels.
(13) The display device described in any one of paragraphs (1) through (11) above, wherein the plurality of segments are horizontally arrayed in each of the pixels.
(14) The display device described in any one of paragraphs (1) through (13), wherein each of the pixels has two segments.
(15) The display device described in any one of paragraphs (1) through (14) above, wherein each of the segments is formed by a plurality of domains of which the orientation directions of liquid crystal molecules are different from one another.
(16) The display device described in any one of paragraphs (1) through (15) above, further including a backlight part, wherein the liquid crystal display part is interposed between the backlight part and the light control part.
(17) The display device described in any one of paragraphs (1) through (15) above, further including a backlight part, wherein the light control part is interposed between the backlight part and the liquid crystal display part.
(18) A display method including:
supplying, in a first display mode, a plurality of pixel signals derived from different items of pixel information respectively to a plurality of segments which are included in each of pixels and driven independently for display execution;
causing each of the segments to execute display based on the pixel signals, and
controlling light coming from or directed to each of the segments.
(19) An electronic apparatus including:
a display device; and
a control part configured to perform operation control using the display device;
wherein the display device includes

a liquid crystal display part configured to have an array of pixels each including a plurality of segments each driven independently, and

a light control part configured to control light coming from or directed to the liquid crystal display part, and

in a first display mode provided by the display device, a plurality of pixel signals derived from different items of pixel information are supplied respectively to the plurality of segments in each of the pixels.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a liquid crystal display part configured to have an array of pixels each including a plurality of segments each driven independently; and
a light control part configured to control light coming from or directed to said liquid crystal display part,
wherein, in a first display mode provided by said display device, a plurality of pixel signals derived from different items of pixel information are supplied respectively to said plurality of segments in each of said pixels.

2. The display device according to claim 1, wherein said different items of pixel information correspond to different perspective images.

3. The display device according to claim 1, wherein said different items of pixel information are in different positions corresponding to either the same perspective image or different perspective images.

4. The display device according to claim 1, further comprising a display drive part configured to have a plurality of intensity correction tables corresponding respectively to said plurality of segments in each of said pixels, said display drive part driving said liquid crystal display part by correcting said pixel information using said plurality of intensity correction tables.

5. The display device according to claim 4, wherein said plurality of intensity correction tables are equivalent to each other, and
wherein said display drive part generates a pixel signal based on the pixel information corresponding to each of said segments.

6. The display device according to claim 4, wherein, in a second display mode provided by said display device, said plurality of intensity correction tables are different from one another, and
wherein said display drive part generates a pixel signal based on the pixel information corresponding to each of said pixels.

7. The display device according to claim 1, wherein said light control part constitutes a barrier part configured to let pass or block light, and
wherein said barrier part has a plurality of first-group liquid crystal barriers and a plurality of second-group liquid crystal barriers of which an opened state and a closed state may be switched.

8. The display device according to claim 7, wherein
in said first display mode, said plurality of first-group liquid crystal barriers are turned into a transparent state and said plurality of second-group liquid crystal barriers are turned into a blocked state to display a plurality of perspective images, and
in said second display mode, said plurality of first-group liquid crystal barriers and said plurality of second-group liquid crystal barriers are turned into the transparent state to display one perspective image.

9. The display device according to claim 1, wherein
said light control part constitutes a barrier part configured to let pass or block light, and
said barrier part has a plurality of fixed openings.

10. The display device according to claim 1, wherein said light control part has a plurality of variable lenses of which the refractive index can be switched.

11. The display device according to claim 1, wherein said light control part has a plurality of fixed lenses.

12. The display device according to claim 1, wherein said plurality of segments are vertically arrayed in each of said pixels.

13. The display device according to claim 1, wherein said plurality of segments are horizontally arrayed in each of said pixels.

14. The display device according to claim 1, wherein each of said pixels has two segments.

15. The display device according to claim 1, wherein each of said segments is formed by a plurality of domains of which the orientation directions of liquid crystal molecules are different from one another.

16. The display device according to claim 1, further comprising a backlight part,
wherein said liquid crystal display part is interposed between said backlight part and said light control part.

17. The display device according to claim 1, further comprising a backlight part,
wherein said light control part is interposed between said backlight part and said liquid crystal display part.

18. A display method comprising:
supplying, in a first display mode, a plurality of pixel signals derived from different items of pixel information respectively to a plurality of segments which are included in each of pixels and driven independently for display execution;
causing each of said segments to execute display based on said pixel signals, and
controlling light coming from or directed to each of said segments.

19. An electronic apparatus comprising:
a display device; and
a control part configured to perform operation control using said display device;
wherein said display device includes
a liquid crystal display part configured to have an array of pixels each including a plurality of segments each driven independently, and
a light control part configured to control light coming from or directed to said liquid crystal display part, and
in a first display mode provided by said display device, a plurality of pixel signals derived from different items of pixel information are supplied respectively to said plurality of segments in each of said pixels.
